(19) United States
(12) Patent Application Publication
(10) Pub. No.: US 2014/0312088 A1
(43) Pub. Date: Oct. 23, 2014

(54) ATTACHMENT TOOL FOR USE WITH VEHICLE-MOUNTED ARTICLE

(71) Applicant: Beat-Sonic Co., Ltd., Nisshin-shi (JP)

(72) Inventor: Eiji MIYAJIMA, Nisshin-shi (JP)

(73) Assignee: Beat-Sonic Co., Ltd., Nisshin-shi (JP)

(21) Appl. No.: 14/248,714

(22) Filed: Apr. 9, 2014

(30) Foreign Application Priority Data
Apr. 18, 2013 (JP) 2013-087047

(51) Int. Cl. B60R 11/02

(52) U.S. Cl. CPC B60R 11/02
USPC 224/570

(57) ABSTRACT

An attachment tool for use with a vehicle-mounted article includes a fitting member fitted in a switch mounting hole which is formed in a dashboard of a vehicle so that a post-fitting switch or the like is attachable to the switch mounting hole and which is covered by a blind lid, and a connecting member having a distal end to which a vehicle-mounted article is connected and formed on a front of the fitting member.

### CROSS-REFERENCE TO RELATED APPLICATIONS

This application is based upon and claims the benefit of priority from the prior Japanese Patent Application No. 2013-87047 filed on Apr. 18, 2013, the entire contents of which are Incorporated herein by reference.

### BACKGROUND

1. Technical Field

The present disclosure relates to an attachment tool for vehicle-mounted articles including cups, smartphones, displays of car navigation system, cameras, radar detectors and drive recorders, and more particularly to an attachment tool used to mount vehicle-mounted articles on a dashboard of vehicle.

2. Related Art

For example, Japanese Patent Application Publication No JR-A-H11-129829 discloses an attachment tool provided with a suction cup as one of types of attachment tools used to mount a vehicle-mounted article on a dashboard of vehicle. Japanese Patent Application Publication No. JP-A-2007-320547 also discloses another attachment tool of the same type as mentioned above. In use of these attachment tools, a suction cup is caused to adhere to a surface of the dashboard, whereby a holder or the like for a vehicle-mounted article is attached to the dashboard.

Furthermore, Japanese Patent Application Publication No. JP-A-H09-240347 discloses an attachment tool provided with a clip. Japanese Patent Application Publication No. JP-A-2006-182270 and Japanese Utility Model Registration No 3005415 also disclose attachment tools provided with clips respectively. In each of these attachment tools, the clip is mounted on a louver of air conditioner outlet provided in the dashboard so as to clip the louver, whereby a holder or the like for the vehicle-mounted article is attached to the dashboard.

In the attachment tool with the suction cup, the suction cup has a strong suction force in order to he prevented from falling off from the dashboard due to oscillating or vibratory motion during running. Accordingly, when the dashboard has a surface made of soft safety padding, the dashboard surface is sometimes damaged by an adsorption mark caused by the strong suction force.

Furthermore, a suction cup interior in a vacuum state at the beginning of adsorption. However, since air gradually enters the suction cup interior, the suction cup fails off from the dashboard before long.

In the case of the attachment tool with the clip, the clip is caused to clip the louver of the air conditioner outlet, so that the attachment tool is mounted to the dashboard. The louvers are swung up and down and right and left for adjustment of direction of airflow. Accordingly, oscillation or vibration caused during running swings a smartphone or a display attached to the vehicle-mounted article holder, with the result that a screen of the smartphone or the display becomes hard to view.

### SUMMARY

Therefore, an object of the disclosure is to provide an attachment tool which can be used to stably mount the vehicle-mounted article on the vehicle dashboard for a long period of time without damaging the dashboard surface.

The present disclosure provides an attachment tool for use with a vehicle-mounted article, including a fitting member fitted in a switch mounting hole which is provided in a dashboard of a vehicle so that a post-fitting switch or the like is attachable to the switch mounting hole and which is covered by a blind lid, and a connecting member having a distal end to which a vehicle-mounted article is connected and provided on a front of the fitting member.

A switch mounting hole is formed in an instrument panel constituting a vehicle dashboard in order that a post-fitting switch may be mounted therein. The switch mounting hole is normally covered with a blind lid. According to the above-described construction, the vehicle-mounted article can be mounted on the instrument panel of the dashboard when the fitting member is fitted into the switch mounting hole. Thus, the unused switch mounting hole can be effectively used.

Furthermore, since the fitting member is fitted into the switch mounting hole, the dashboard can be prevented from being damaged and the vehicle-mounted article can be stably attached to the dashboard.

In one embodiment, the connecting member includes a plurality of ball joints. Orientations of a smartphone, a display of car navigation system, camera, illumination lamp and the like can be adjusted or rotated in the up-down and right-left directions. This can improve the usability of the vehicle-mounted article.

In another embodiment, the attachment tool further includes lock pieces provided on a top side and an underside or right and left sides of the fitting member so as to be displaceable inward and outward with respect to the sides of the fitting member, respectively, the lock pieces having lock surfaces lockable to a peripheral edge of the switch mounting hole and guide surfaces extending rearward from outer ends of the lock surfaces and being inclined. In this construction, when the fitting member is inserted into the switch mounting hole, the guide surfaces are brought into sliding contact with the peripheral edge of the switch mounting hole, whereby the lock pieces are displaced inward with respect to the sides of the fitting member. The guide surfaces are inclined so that the lock pieces are displaced outward with respect to the sides of the fitting member when outer ends of the lock surfaces have passed the peripheral edge of the switch mounting hole, whereby the lock surfaces are locked to the peripheral edge of the switch mounting hole. According to the above-described construction, she attachment tool can be easily mounted in the switch mounting hole by a simple operation, that is, by inserting the fitting member into the switch mounting hole.

In further another embodiment, the lock surfaces are inclined so that in a case where the fitting member is pulled out of the switch mounting hole when inserted into the switch mounting hole until the lock surfaces lock to the peripheral edge of the switch mounting hole, the lock surfaces are brought into sliding contact with the peripheral edge of the switch mounting hole and the lock pieces are displaced inward with respect to the sides of the fitting member, so that the lock surfaces are released from a locked state to the peripheral edge of the switch mounting hole, wherein the fitting member has a pair of locking members which are provided in the front thereof so as to be movable inward and outward with respect to the fitting member, and wherein when the locking members are moved inward, distal ends of the locking members abut on bottoms of the lock pieces thereby to prevent the lock pieces from inward displacement.

According to the above-described construction, the lock pieces are prevented from inward displacement when the locking members are caused to enter the inside of the fitting member through the front of the fitting member. Accordingly, the lock surfaces are maintained in the locked state relative to the peripheral edge of the switch mounting hole Consequently, the fitting member can be prevented from inadvertently falling off from de switch mounting hole.

In further another embodiment, the fitting member has a front formed with a through hole through which a cable connected to a vehicle-mounted article extends, and the connecting members have respective through holes through which the cable extends. According to the above-described construction, when the vehicle-mounted article is electrically charged from the power-supply battery of the vehicle, the cable is inserted through the holes, so that the cable can be wired into the interior of the attachment tool. Consequently, an appearance of the attachment tool can be prevented from being impaired and the cable can be prevented from becoming hindrance to operating the smartphone.

### BRIEF DESCRIPTION OF THE DRAWINGS

In the accompanying drawings:

FIG. 1 is a side elevation of a vehicle-mounted article attachment tool according to a first embodiment;

FIG. 2 is a partial sectional view of the attachment tool;

FIG. 3 is a perspective view of the attachment tool;

FIG. 4 is a schematic diagrammatic view of the dashboard of a vehicle;

FIG. 5 is a perspective view of a smartphone holder;

FIG. 6 is a side elevation of a vehicle-mounted article attachment tool according to a second embodiment;

FIG. 7 is a partial perspective view of a smartphone holder attachment tool according to a third embodiment;

FIG. 8 is a partial perspective view of a smartphone holder attachment tool according to a fourth embodiment;

FIG. 9 is a partial perspective view of a smartphone holder attachment tool according to a fifth embodiment; and

FIG. 10 is a partial perspective view of a smartphone holder attachment tool according to a sixth embodiment.

### DETAILED DESCRIPTION

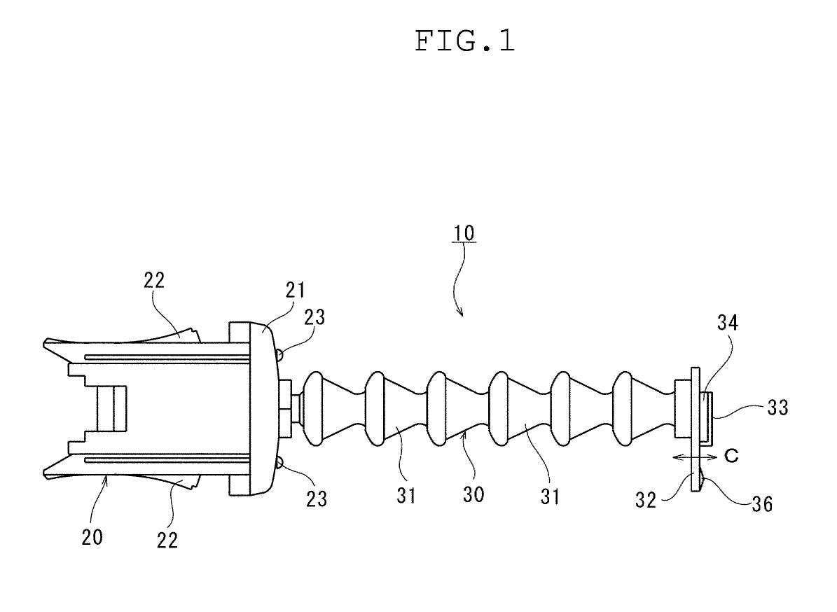

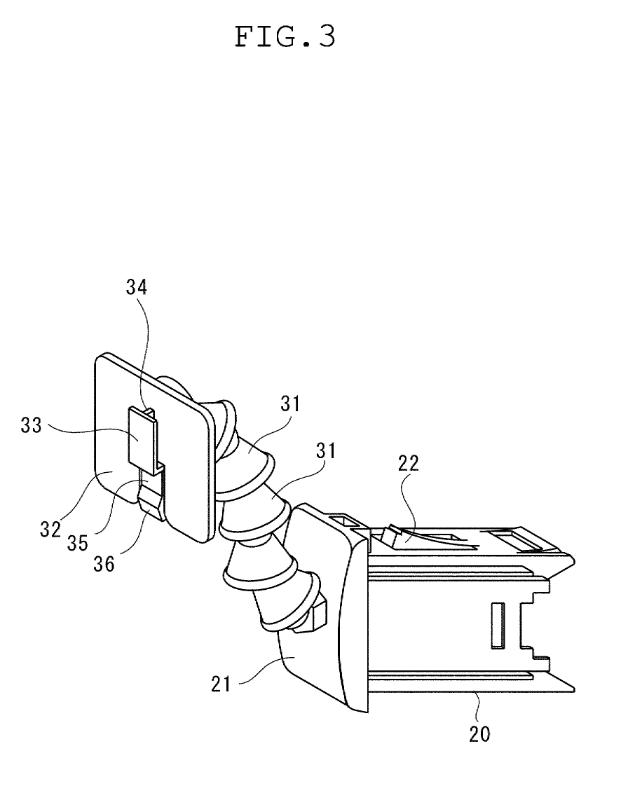

Several embodiments will be described with reference to the accompanying drawings. FIGS. 1 to 3 illustrate an attachment tool 10 for a vehicle-mounted article according to a first embodiment. Referring to FIG. 1, the attachment tool 10 is provided for mounting a smartphone and includes a fitting member 20 and a connecting member 30 to which a smartphone holder 50 is to be connected. The connecting member 30 includes a plurality of ball joints 31 and a hook plate 32. The fitting member 20, the ball joints 31 and the hook plate 32 are all plastic molded components.

The fitting member 20 is formed into the shape of a substantially rectangular parallelepiped box and has a rear end face formed with an opening 20a and a front face 21 to which a proximal end of the connecting member 30 is connected. The connecting member 30 has a distal end to which the hook plate 32 is connected.

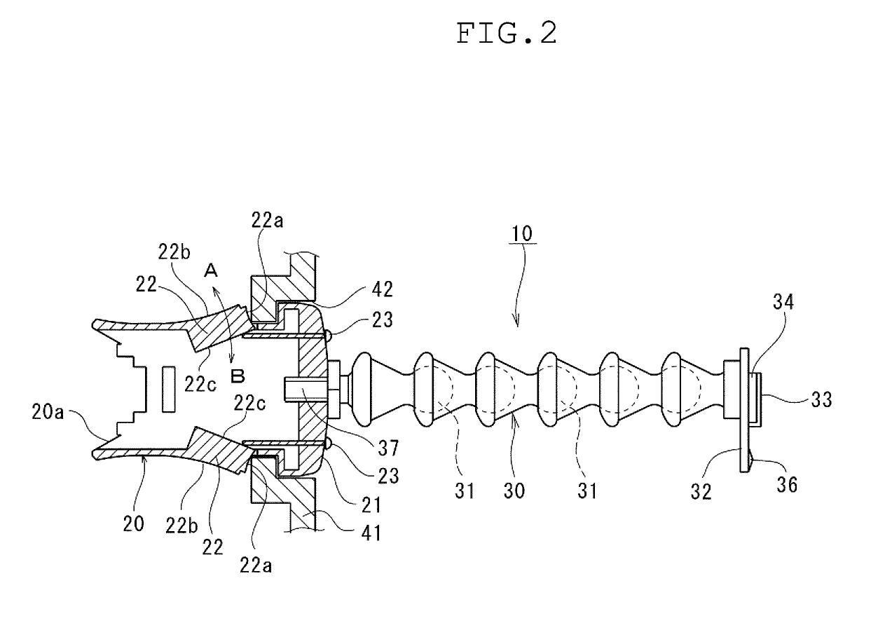

The fitting member 20 has a top and an underside both formed with lock pieces 22 respectively. The lock pieces 22 are flexible so as to be displaceable inward and outward with respect to the fitting member 20 as shown by arrows A and B in FIG. 2. Each lock piece 22 has a locking surface 22a and a guide surface 22b extending rearward from an outer end of the locking surface 22a, The locking surface 22a is formed into an inclined surface and the guide surface 22b is also formed into an inclined surface The fitting member 20 has a front 21 through which two small screw holes are formed. Two lock screws 23 are screwed into the screw holes so as to be movable forward and backward, respectively. When the lock screws 23 are screwed into the respective screw holes to be driven forward, distal ends of the lock screws 23 abut against bottoms 22c of the lock pieces 22 respectively. When the lock screws 23 are driven rearward, the distal ends of the lock screws 23 are retreated from the bottoms 22c of the lock pieces 22 respectively.

The connecting member 30 includes a plurality of ball joints 31 one of which constitutes a proximal end thereof A bolt member 37 is fixed to the ball joint 31. The front 21 of the fitting member 20 has another through screw hole through which the bolt member 37 is screwed, whereby the proximal end of the connecting member 30 is connected to the front 21 of the fitting member 20. The connecting member 30 has a distal end constituted by another ball joint 31 to which a hook plate 32 is secured. The hook plate 32 has a hook 33, a hooking part 34 and a lock piece 35 all formed integrally therewith. The hook 33 has a generally L-shaped section. The lock piece 35 droops from a lower end of the hook 33 and has a lower end formed with a round protrusion 36. The lock piece 35 is flexible so as to be capable of displacing the protrusion 36 in a front-rear direction as shown by arrow C in FIG. 1.

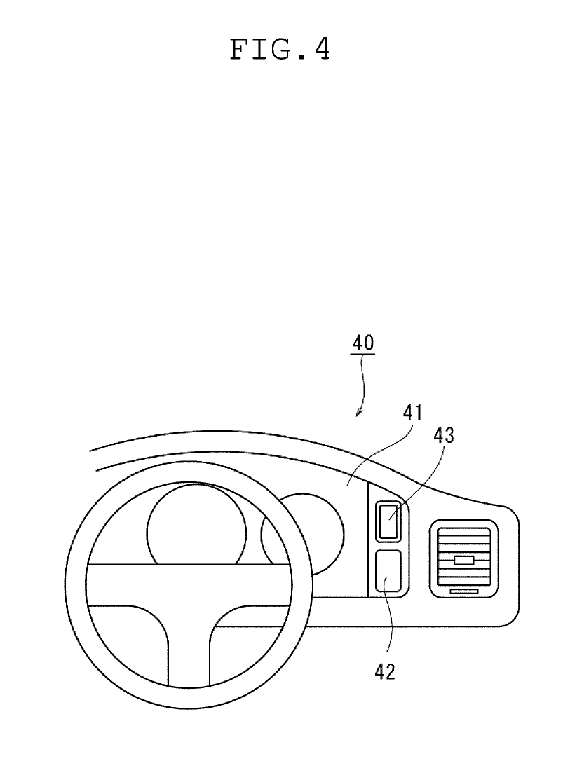

The attachment tool 10 constructed as described above will work as follows. The attachment tool 10 is mounted in a switch mounting hole 42 formed in an instrument panel 41 constituting a vehicle dashboard 40, as shown in FIG. 4. The switch mounting hole 42 is normally covered with a blind lid 43, which is detached when a switch is retrofitted. In the attachment tool 10, the fitting member 20 is fitted into the switch mounting hole 42 after the blind lid 43 has been detached.

When the fitting member 20 is fitted into the switch mounting hole 42, the lock screws 23 are retreated so that the distal ends thereof are prevented from abutting against the bottoms 22c of the lock pieces 22. When the fitting member 20 is inserted into the switch mounting hole 42, qui de surfaces 22b are brought into sliding contact with a peripheral edge of the switch mounting hole 42, so that the lock pieces 22 are displaced inward in the direction of arrow B in FIG. 2. When outer ends of the lock surfaces 22a have passed the peripheral edge of the switch mounting hole 42, the lock pieces 22 are displaced outward as shown by arrow A. Accordingly, the lock surfaces 22a are engaged with a peripheral edge of the switch mounting hole 42 thereby to be locked, whereby the fitting member 20 is attached into the switch mounting hole 42.

The fitting member 20 is thus inserted into the switch mounting hole 42 until the lock surfaces 22a are locked to the peripheral edge of the switch mounting hole 42. In this case, when the fitting member 20 is pulled out of the switching attachment hole 20, the lock surfaces 22a are brought into sliding contact with the peripheral edge of the switch mounting hole 42, so that the lock pieces 22 are displaced inward as shown by arrow B in FIG. 2 with the result that the lock surfaces 22a are released from the locked state to the peripheral edge of the switch mounting hole 42.

As described above, the fitting member 20 is inserted into the switch mounting hole 42 until the lock surfaces 22a are locked to the peripheral edge of the switch mounting hole 42. In this state, when the lock screws 23 are screwed into the fitting member 20 so that the distal ends of the lock screws 23 abut on the bottoms 22a of the lock pieces 22 respectively, the lock pieces 22 are prevented from inward displacement. As a result, the fitting member 20 locked in the switch mounting hole 42 thereby to be prevented from being pulled out of the switch mounting hole 42.

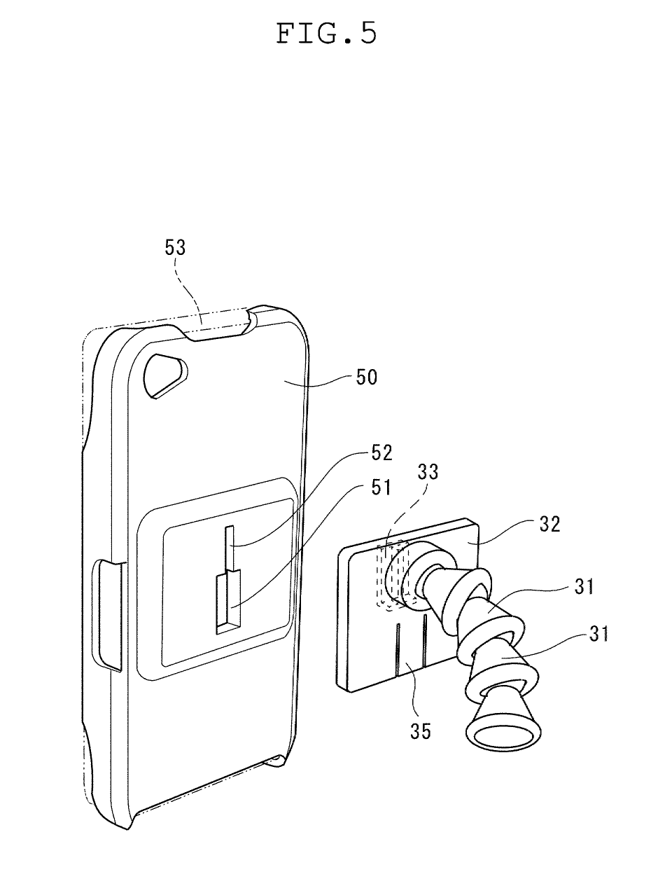

A smartphone holder 50 as shown in FIG. 5 is attached to the hook plate 32 of the attachment tool 10 mounted in the switch mounting hole 42. The smartphone holder 50 has an underside formed with first and second hook holes 51 and 52 communicating with each other. The hook 33 is inserted into the first hook hole 51 and thereafter displaced upward so that the hooking part 34 is hooked into the second hook hole 52. In this case, the round protrusion 36 of the lock piece 35 abuts on a lower end of the first hook hole 51, whereby the hooking part 34 is prevented from falling off from the second hook hole 52. A smartphone 53 is attached to the surface side of the smartphone holder 52 attached to the hook plate 32. The orientation of the smartphone 53 is adjusted by the ball joints 31.

According to the above-described construction, the smartphone holder 50 can be attached to the instrument panel 41 of the dashboard 40 when the fitting member 20 is fitted into the switch mounting hole 42. Consequently, the unused switch mounting hole 42 can be effectively used.

Since the fitting member 20 is fitted into the switch mounting hole 42, the smartphone holder 50 can be stably mounted on the dashboard 40 without damaging the surface of the dashboard 40.

The usability of the smartphone 53 can be improved since the smartphone holder 50 can be detached from the hook plate 32 of the attachment tool 10. Furthermore, the fitting member 20 and the hook plate 32 are connected to each other by the ball joints 31. Accordingly, since the orientation of the smartphone 53 held on the smartphone holder 50 is freely changeable, the usability of the smartphone 53 can be further improved.

The attachment tool 10 can be attached into the switch mounting hole 42 by an easy operation, namely, by inserting the fitting member 20 into the switch mounting hole 42. Furthermore, the lock pieces 22 are prevented from inward displacement when the lock screws 23 are screwed through the front of the fitting member 20 into the fitting member 20. Accordingly, the lock surfaces 22a are maintained in the locking state relative to the peripheral edge of the switch mounting hole 42, with the result that the fitting member 20 can be prevented from inadvertently falling off from the switch mounting hole 42.

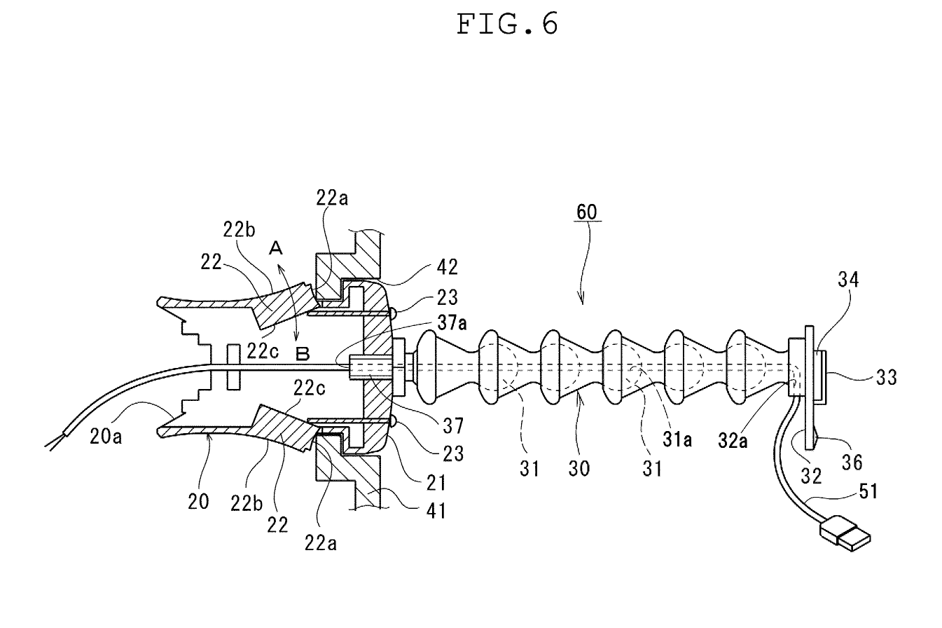

FIG. 6 illustrates an attachment tool 60 for use with a vehicle-mounted article, according to a second embodiment. The attachment tool 60 includes the bolt member 37, the ball joints 31 and the hook plate 32 all of which have through holes 37a, 31a and 32a respectively. These holes 37a, 31a and 32a communicate with one another. The hole 32a of the hook plate 32 is open in a lower side surface of the hook plate 32. A charging cable 51 extends through the holes 37a, 31a and 32a.

The attachment tool 60 has the same construction as the attachment, tool 10 according to the first embodiment in the other respects. Accordingly, identical or similar parts are labeled by the same reference symbols as those in the first embodiment, and the description of these parts will be eliminated.

According to the construction of the second embodiment, when the smartphone is electrically charged from the power-supply battery of the vehicle, the cable 51 is inserted through the holes 37a, 31a and 32a, so that the cable 51 can be wired into the interior of the attachment tool 60. Consequently, an appearance of the attachment tool 60 can be prevented from being impaired and the cable 51 can be prevented from becoming hindrance to operating the smartphone.

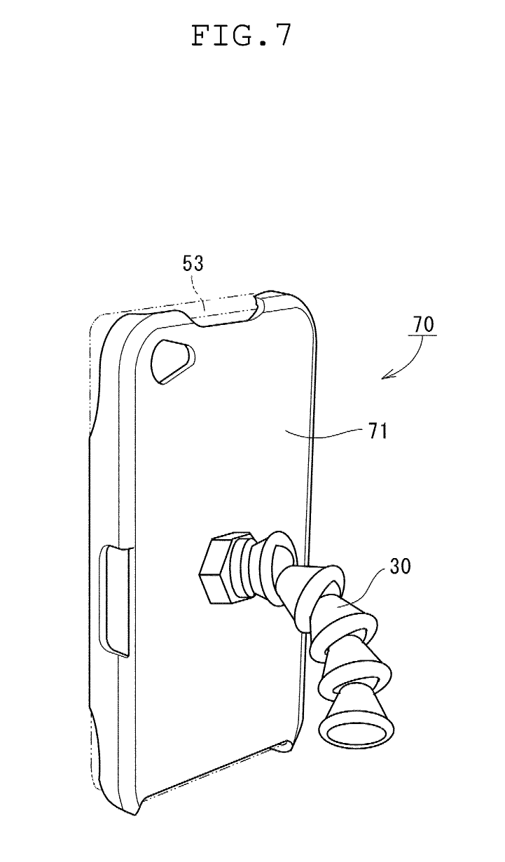

FIG. 7 illustrates an attachment tool 70 according to a third embodiment. The smartphone holder 71 is directly secured co the distal end of the connecting member 30 in the attachment tool 70. The attachment tool 70 has the same construction as the attachment tool 60 according to the second embodiment in the other respects. Accordingly, identical or similar parts are labeled by the same reference symbols as those in the second embodiment, and the description of these parts will be eliminated.

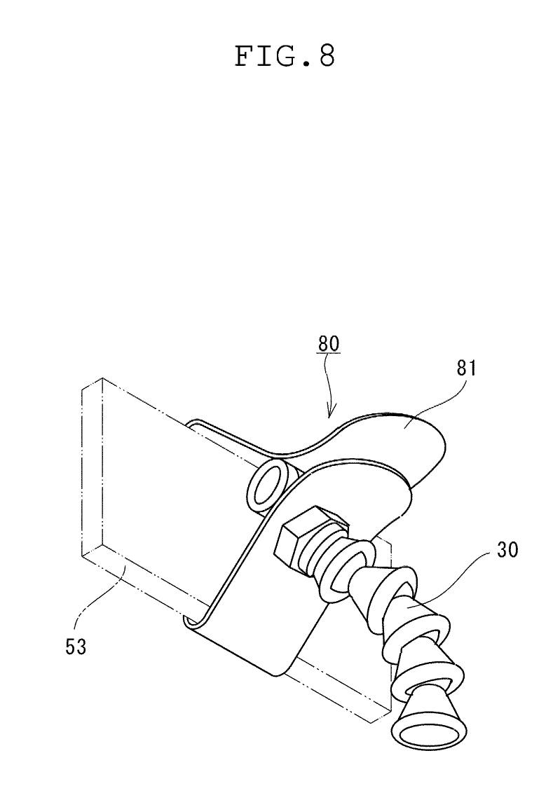

FIG. 8 illustrates an attachment tool 80 according to a fourth embodiment. In the attachment tool 80, a clip 81 capable of holding the vehicle-mounted article such as a smartphone 53 is secured to the distal end of the connecting member 30.

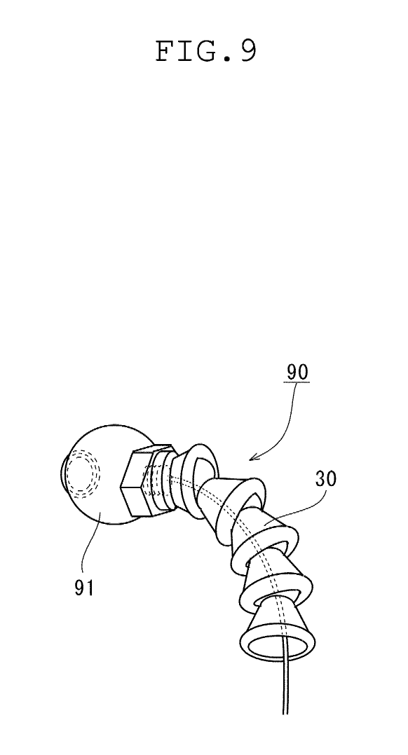

FIG. 9 illustrates an attachment tool 90 according to a fifth embodiment. In the attachment tool 90, a video camera head 91 is secured to the distal end of the connecting member 30.

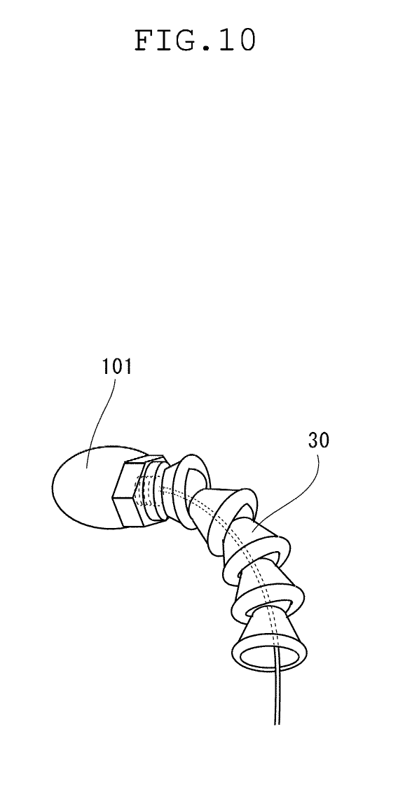

FIG. 10 illustrates an attachment tool 100 according to a sixth embodiment. In the attachment tool 100, an illumination lamp 101 is secured to the distal end of the connecting member 30.

The attachment tools 70, 80, 90 and 100 have the same construction as the attachment tool 60 according to the second embodiment in the other respects. Accordingly, identical or similar parts are labeled by the same reference symbols as those in the second embodiment, and the description of these parts wall be eliminated.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. An attachment tool for use with a vehicle-mounted article, comprising:
a fitting member fitted in a switch mounting hole which is provided in a dashboard of a vehicle so that a post-fitting switch or the like is attachable to the switch mounting hole and which is covered by a blind lid; and
a connecting member having a distal end to which a vehicle-mounted article is connected and provided on a front of the fitting member.

2. The attachment tool according to claim 1, wherein the connecting member includes a plurality of ball joints.

3. The attachment tool according to claim 1, further comprising:
lock pieces provided on a top side and an underside or right and left sides of the fitting member so as to be displaceable inward and outward with respect to the sides of the fitting member, respectively, the lock pieces having lock surfaces lockable to a peripheral edge of the switch mounting hole and guide surfaces extending rearward from outer ends of the lock surfaces and being inclined, wherein:
when the fitting member is inserted into the switch mounting hole, the guide surfaces are brought into sliding contact with the peripheral edge of the switch mounting hole, whereby the lock pieces are displaced inward with respect to the sides of the fitting member; and
the guide surfaces are inclined so that the lock pieces are displaced outward with respect so the sides of the fitting member when outer ends of the lock surfaces have passed the peripheral edge of the switch mounting hole, whereby the lock surfaces are locked to the peripheral edge of the switch mounting hole.

4. The attachment tool according to claim 3, wherein the lock surfaces are inclined so that in a case where the fitting member is pulled out of the switch mounting hole when inserted into the switch mounting hole until the lock surfaces lock to the peripheral edge of the switch mounting hole, the lock surfaces are brought into sliding contact with the peripheral edge of the switch mounting hole and the lock pieces are displaced inward with respect to the sides of the fitting member, so that the lock surfaces are released from a locking state to the peripheral edge of the switch mounting hole;
wherein the fitting member has a pair of locking members which are provided in the front thereof so as to be movable inward and outward with respect to the fitting member; and
wherein when the locking members are moved inward, distal ends of the locking members abut on bottoms of the lock pieces thereby to prevent the lock pieces from inward displacement.

5. The attachment tool according to claim 1, wherein:
the fitting member has a front formed with a through hole through which a cable connected to a vehicle-mounted article extends; and
the connecting members have respective through holes through which the cable extends.
